(19) United States
(12) Patent Application Publication
(10) Pub. No.: US 2008/0077384 A1
(43) Pub. Date: Mar. 27, 2008

(54) DYNAMICALLY TRANSLATING A SOFTWARE APPLICATION TO A USER SELECTED TARGET LANGUAGE THAT IS NOT NATIVELY PROVIDED BY THE SOFTWARE APPLICATION

(75) Inventors: CIPRIAN AGAPI, LAKE WORTH, FL (US); BRENT D. METZ, DELRAY BEACH, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/534,500

(22) Filed: Sep. 22, 2006

(51) Int. Cl. G06F 17/28

(52) U.S. Cl. 704/2

(57) ABSTRACT

The present solution includes a method for dynamically translating application prompts to internationalize software applications for a non-native language that is not specifically supported by the application. In the solution, application prompts can be identified that are associated with a software application. Each application prompt can include text written in an original language. An attempt of the software application to render one of the application prompts can be intercepted and dynamically translated. The translated text can be substituted for the original text. The application prompt can then be rendered.

### BACKGROUND

1. Field of the Invention

The present invention relates to the field of software application internationalization and, more particularly, to dynamically translating a software application to a user selected target language that is not natively provided by the software application.

2. Description of the Related Art

Computing systems and software implemented for computing systems have become an integral part of routine life for many people residing in many different countries. These people communicate in many different principal languages. Software written in the principal language of a user is easier for that user to utilize than software written in a different language, which the user may or may not understand.

Currently, English is a predominant language in which software is implemented. That is, application prompts, such as menu items, text entry labels, help messages, toolbar labels, and other GUI elements, are written in English for a majority of software applications. This can pose a problem for non-English speakers attempting to utilize popular software applications. For example, an international student studying in the United States and using university computing devices may be forced to use applications written in English, which can disadvantage that student compared their peers.

In another example, emerging markets, such as South Korea and India, can favor software written in that market's predominant language over software written in English. In these emerging markets, relatively obscure software applications written in the market's predominant language can be more popular than an international standard application, such as OPEN OFFICE or MICROSOFT OFFICE, that does not provide application prompts in the market's predominant language. This situation applies to locally executing software applications, Web deployed applications, and to Web sites.

Some software applications are written in a hard-coded manner for few, language-specific versions, such as English, Spanish, and French. Different versions of the software must be obtained for different users, assuming the different users want to interact using different languages. Other software applications are internationalized, so that different substitutable language packs exist for the application. If a user desires application prompts for a particular supported language, a language pack for that language is loaded into the application, which changes all language prompts accordingly.

Development of software for multiple languages or in an internationalized fashion that supports different language packs is expensive. Even when software is internationalized to support some languages, desirable languages that do no have a huge user base are typically ignored. Today, approximately 95-99 percent of software applications available for desktop platforms are not available in more than a handful of languages.

### SUMMARY OF THE INVENTION

The present invention discloses a solution for dynamically converting application prompts of a software application to a desired language, even when the desired language is not natively supported by the software application. More specifically, font rendering requests for a text segment associated with an application prompt can be intercepted before being rendered. The text segments that are written in a first language can be conveyed to a translation engine, which can dynamically convert the text segments into a second, user-selected language. The translated text can then be used in place of the original text.

In one embodiment, the translation engine can be remotely located from a machine upon which the software application executes. For example, the translations can occur using a network element, which dynamically translates application prompts in real-time or in near-real time. Additionally, the dynamic translation solution can occur in an application independent fashion and can generically work with any software application.

The translation engine can also include a configurable accuracy threshold, where only those applications having a translation accuracy value over the accuracy threshold are converted. In one configuration, the solution can include a tooltip or flyover for each translated application prompt that contains the original, non-translated text. This tooltip can help a user somewhat familiar with the original language understand mistranslated prompts. A further extension of the solution can permit a user to flag mistranslations and to apply a user-specified translation for the original text in the future. Thus, translation accuracy can be improved for a particular application or user instance by using a training loop based upon a combination of user-specified translations and automatic translations.

The present invention can be implemented in accordance with numerous aspects consistent with material presented herein. For example, one aspect of the present invention can include a method for dynamically translating application prompts. The method can identify application prompts associated with a software application. Each application prompt can include text of the original language. An attempt by the software application to render one of the prompts can be detected and redirected to a dynamic translation engine. The dynamic translation engine can dynamically and automatically translate the original language into a target language. The translated text can be substituted for the original text and the modified application prompt can be rendered.

Still another aspect of the present invention can include a method for adapting software applications for new languages. The method can identify a software application configured for a first language. A desired second language can be detected. The machine upon which the software application is implemented can lack native support for the second language. A display object that includes original text written in the first language can be determined. The original text can be conveyed to a remotely located networked machine along with an indicator of the second language. The network machine can translate the text into the second language and can convey the translation back to the original machine. The original text of the display object can be dynamically replaced with the translated text. The display object that includes the translated text can then be displayed.

Yet another aspect of the present invention can include a method for adapting software applications for new languages. The method can receive one or more translation requests from remotely located software applications. The requests can be requests to dynamically translate application prompts containing text into a language not natively supported by the software application. The application prompts can be dynamically translated in accordance with the details contained in the translation requests. The translated application prompts can be provided to the software application from which a corresponding translation request originated. The application prompts can include application menu items, textual labels for graphical user interface (GUI) elements, and other graphical objects of the software application.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system that includes a computing device having dynamic translation capabilities in accordance with an embodiment of the inventive arrangements disclosed herein.

FIG. 2 shows a graphical user interface for which dynamic translations are performed in accordance with an embodiment of the inventive arrangements disclosed herein.

FIG. 3 is a flow chart for selectively implementing dynamic translations of application prompts in accordance with an embodiment of the inventive arrangements disclosed herein.

FIG. 4 is a schematic diagram of a system for implementing dynamic translations of application prompts in accordance with an embodiment of the inventive arrangements disclosed herein.

### DETAILED DESCRIPTION OF THE INVENTION

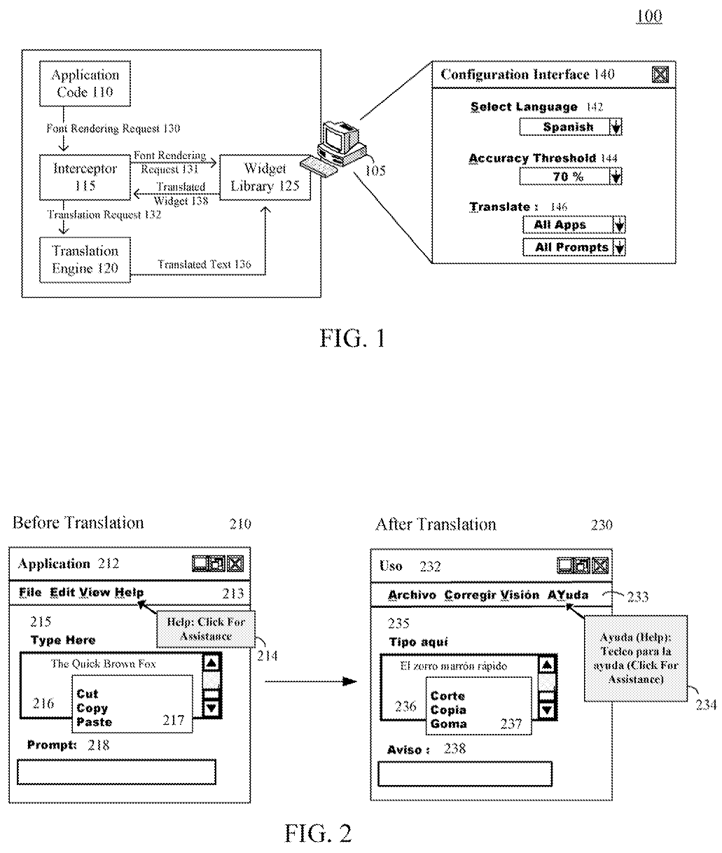

FIG. 1 is a schematic diagram of a system 100 of a computing device having dynamic translation capabilities in accordance with an embodiment of the inventive arrangements disclosed herein. The computing device 105 can include application code 110 for one or more software applications. Each software application can execute programmatic instructions in accordance with application code 110. The software application can be an application having a visual output modality through which text is visually presented to a user.

When executing, the application code 110 can issue font rendering requests 130 for application prompts that contain text. An application prompt can be an interface object or widget that is rendered and displayed to a user. Application prompts can include, for example, menu text, popup text, textual labels, help text, text appearing within drop down lists, user entered textual content displayed in text boxes, tables including text, and the like. Generally, an application prompt can be any displayable object or collection of displayable objects that include text.

It should be noted briefly that most conventional software applications permit configurable adjustments for different fonts and font sizes. These applications send font rendering requests directly to a widget library 125, which is often a dynamic link library (DLL) accessed via an application program interface (API). The widget library 125 produces renderable widgets or objects that contain text rendered in accordance with previously established settings. These settings can include a user established font size, type, and color scheme, for example.

System 100 uses interceptor 115 to intercept the font rendering requests 130 before those requests are sent to the widget library 125 for processing. The font rendering request 130 can be any request associated text that is to be rendered. The interceptor 115 can identify an original language for the text of the font rendering request 130. This original language can be compared against a user desired language, which can be established by configurable parameters, such as those entered using configuration interface 140.

When the original language is a desired language, the interceptor 115 can route the font rendering request 131 directly to the widget library 125. Otherwise, the interceptor 115 can determine whether the desired language is natively supported by the software application. That is, many software applications have been internationalized so that they support multiple languages through language specific language packages. If a language package exists for the desired language, it is used. When no native support is available for the desired language, the interceptor can generate a translation request 132, which is sent to the translation engine 120. The translation request 132 can include the original text segment, an indicator of the desired language, and an optional indicator of the original language. When the original language is not specified in the translation request 132, the original language can be automatically determined by the translation engine 120.

The translation engine 120 can dynamically perform translations from the original language to the desired language. The translation engine 120 can be a software component implemented independent of the software application associated with the application code 110. The translation engine 120 can be software local to computing device 105 and/or can be remotely located software accessed via a network connection (not shown). A solution utilizing both local and remote translation engines 120 can be implemented to permit limited dynamic translations when no network connection is available and to permit more robust or accurate translations using a remote engine 120 when a network connection is present. The translation engine 120 can convey translated text 136 to widget library 125 for processing. Widget library 125 can generate a translated widget 138, which includes the translated text instead of the original text.

The configuration interface 140 can permit a user to establish language settings for one or more applications, including the application associated with application code 110. The interface 140 can include a language setting 142, threshold setting 144, translation settings 146, and the like. The language setting 142 can specify a desired language into which application prompts or textual objects are to be translated. For example, the language setting 142 can specify the Spanish language, which may not be natively supported for all applications residing upon the computing device 105 to which the setting 142 applies.

When dynamic translations are to be performed, translation accuracy can vary. The accuracy threshold setting 144 can establish a minimum accuracy that is required before translations are to be performed. For example, if the translation engine 120 estimates a translation accuracy of sixty percent and the setting 144 is set at seventy percent, no dynamic translations will occur. If the estimated translation accuracy exceeds the accuracy threshold setting 144, dynamic translations can be performed.

The translation settings 146 can establish setting for the scope of dynamic translations. For example, translation settings 146 can indicate all applications of the computing device 105 are to be translated into the language indicated by setting 142; Other selectable options can limit translations to a definable set of applications to specific user-designated applications. For instance, all internationalized software applications can be selected, all applications other than games can be selected, a specific application can be selected, and the like. The translation settings 146 can also specify groups of application prompts that are to be translated and groups that are not to be translated. For example, setting 146 can specify that menu prompts, textual popups, and fly over text are to be translated, but that help items are not to be translated.

It should be appreciated that the settings 142-146 shown in interface 140 are for illustrative purposes only and the invention is not to be construed as limited in this regard. Other settings or alternative configuration options are able to be utilized in system 100. For example, a configurable responsiveness setting (not shown) can be established which only performs dynamic translations (assuming the translation engine 120 is remotely located) when relatively low transmission delays exist when conveying data between the computing device 105 and the translation engine 120. In another example, the accuracy thresholds can be established at a lower granularity level, such as different thresholds for different categories of application prompts (e.g., menu items, selections lists, textual labels, and the like).

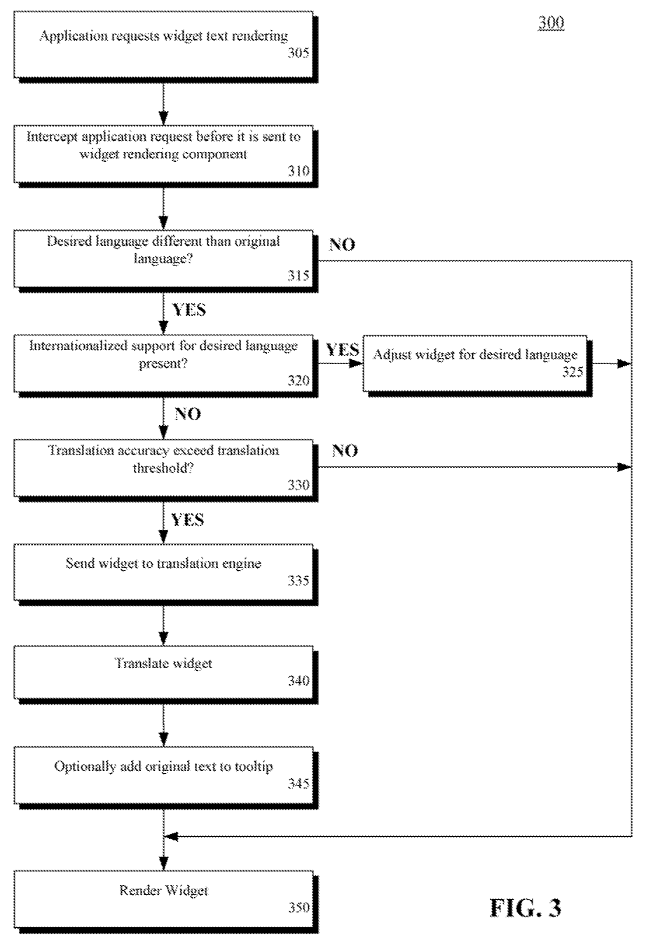

FIG. 2 shows a graphical user interface for which dynamic translations are performed in accordance with an embodiment of the inventive arrangements disclosed herein. The translations can be performed using system 100. Interface 210 shows an application interface as it exists before dynamic translations are performed and interface 230 shows the same application interface after dynamic translations.

Interface 210 can include application prompts 212-218 originally in English. The application prompts 212-218 can include a title prompt 212, a menu prompt 213, a flyover prompt 214, a textual prompt 215, a presented content item 216, a popup item 217, a textual prompt 218, and the like. Interface 230 can include analogous prompts 232-238, which are presented in Spanish. For example, a title prompt 212 of “Application” can be dynamically translated into “Uso” of title prompt 232. In another example, textual prompt 215 of “Type Here” can be dynamically translated into “Tipo Aqui” of textual prompt 235.

One optional feature of the invention can present original text in interface 230 to mitigate against mistranslation errors. For example, a tool tip can be provided for each translated item, which includes the original text. In FIG. 2, flyover prompt 234 can provide additional information for the Ayuda menu item. In parenthesis next to the additional information, original text can be presented. As illustrated, flyover prompt 234 can include “Ayuda (Help): Tecleo para la ayuda (Click For Assistance).”

FIG. 3 is a flow chart 300 for selectively implementing dynamic translations of application prompts in accordance with an embodiment of the inventive arrangements disclosed herein. Chart 300 can be implemented in the context of a system 100.

In step 305 of chart 300, an application can issue one or more widget text rendering request. The request can, for example, be sent to a Widget API. In step 310, an automatic translation layer of a computing system can intercept the requests. In step 315, an original language and a desired language for text associated with the widget request can be determined. The original language can be a default language in which application prompts are written, before translations are provided. A desired language can be established in many different ways. For example, a desired language can be explicitly established by a user setting.

In another example, a desired language can be inferred based upon a location or locale of a computing device upon which results of a software application are displayed. Using a locale can be particularly advantageous for Web based applications that are delivered to many different computing devices in many different countries. For instance, when a computing device is located in Japan, a desired language inferred from a locale of the device can be Japanese. When a computing device is located in France, a desired language inferred from the locale can be French. Inferred languages based upon locale can be overwritten by explicit user selection of a desired language.

When step 315 determines that the original language (default language) and the desired language (locale inferred language) are the same, processing can progress to step 350, where the widget can be rendered. Otherwise, the method can progress from step 315 to step 320, where a determination can be made as to whether an internationalization layer exists for the application that supports the desired language. If so, a language pack associated with the desired language can be utilized for the application. This causes the widget, in step 325, to be statically adjusted for the desired language. After the conversion, step 350 can be implemented, where the widget is rendered.

In step 330, which occurs when no native support for the desired language exists, a translation accuracy threshold can be determined. When an estimated accuracy for dynamic translation unfavorably compares to the threshold, the method can progress to step 350, where the widget can be rendered with text still in the original language. When the estimated accuracy favorably compares to the threshold in step 330, step 335 can execute, where the widget including the original text can be sent to a translation engine. In step 340, the original text can be translated into the desired language. In optional step 345, the original text that has been translated can be added to a widget tooltip to mitigate against mistranslation errors. Step 350 can then execute, where the dynamically translated widget is rendered.

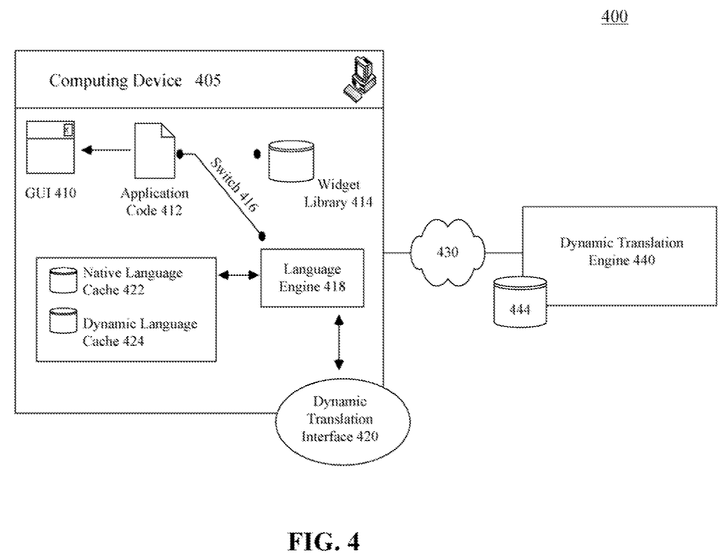

FIG. 4 is a schematic diagram of a system 400 for implementing dynamic translations of application prompts in accordance with an embodiment of the inventive arrangements disclosed herein. System 400 is one contemplated embodiment for implementing system 100. System 400 includes a computing device 405 connected to a remotely located dynamic translation engine 440 via network 430.

The computing device 405 can present a graphical user interface (GUI) 410 generated from application code 412 of an associated software application. An option can be provided to present text of the GUI 410 in multiple languages, which includes languages not natively supported by the computing device 405. When using a default language, switch 416 can be set to route font rendering requests directly to widget library 414. The widget library 414 can generate widgets, application prompts, and/or graphical objects that are displayed within GUI 410.

When a language other than a default is desired, the switch 416 can route font rendering requests to language engine 418. Language engine 418 can search a data store 422 that contains languages locally (or natively) supported by the software application to see if support for the desired language is available. If so, a language package associated with the desired language can be utilized. When native support is lacking, the language engine 418 can send a language request to a dynamic translation interface 420. The dynamic translation interface 420 can be an API that interacts with dynamic translation engine 440.

The dynamic translation engine 440 can be a translation engine having an ability to dynamically translate text from one language to another. In one embodiment, engine 440 can be the WEBSHPERE Translation Server's Machine Translation engine produced by International Business Machines Corporation (IBM) of Armonk, N.Y.. Translated text in the desired language can be conveyed from engine 440 over network 430 to interface 420. The translated text can be ultimately conveyed to widget library 414, which renders a graphical object including the translated text for display within GUI 410.

System 400 can implement numerous options for minimizing dynamic translation delays and for improving translation accuracy. For example, computing device 405 can include a dynamic language cache 424 that caches text translated by dynamic translation engine 440. When cache 424 includes a translation for a particular text segment, that translation can be used and a new call to engine 440 is unnecessary. Moreover, cache 424 can pre-fetch translations for text contained in application prompts of a software application, such as menu prompts and textual prompts, before font rendering requests associated with the pre-fetches are made.

In another embodiment, system 400 can permit a user to override a dynamic translation provided for an original text with a user specified translation. User specified translations can be stored in a data store 444 accessible by engine 440. When future translation requests are sent to engine 440, the user specified translation can be used instead of a dynamic translation. This extension permits a training loop to be established for the translation engine 440. Because a majority of application prompts (e.g., menu text, toolbar text, and the like) are used relatively consistently across multiple applications, use of a training loop that permits user feedback to improve accuracy can rapidly increase the accuracy of application prompts generated by engine 440.

In one configuration, user specified translations can be used in a user specific and/or application specific fashion. In another configuration, user provided translations can be selectively used for other applications and/or for other users whenever a translation accuracy for original text falls below a configured threshold, such as ninety percent, and/or whenever a confidence level associated with the manual translation is sufficiently high. When multiple users provide the same manually specified translation for the same original text, a confidence level for the user-specified translation can be increased.

Network 430 can include any hardware/software/and firmware necessary to convey digital content encoded within carrier waves. Content can be contained within analog or digital signals and conveyed through data or voice channels. The network 430 can include local components and data pathways necessary for communications to be exchanged among computing device components and between integrated device components and peripheral devices. The network 430 can also include network equipment, such as routers, data lines, hubs, and intermediary servers which together form a packet-based network, such as the Internet or an intranet. The network 430 can further include circuit-based communication components and mobile communication components, such as telephony switches, modems, cellular communication towers, and the like. The network 430 can include line based and/or wireless communication pathways.

Data stores 414, 422, 424, and 444 can be a physical or virtual storage spaces configured to store digital content. Each of the data stores 414, 422, 424, and 444 can be physically implemented within any type of hardware including, but not limited to, a magnetic disk, an optical disk, a semiconductor memory, a digitally encoded plastic memory, a holographic memory, or any other recording medium. Further, each data store 414, 422, 424, and 444 can be a stand-alone storage unit as well as a storage unit formed from a plurality of physical devices. Additionally, content can be stored within data stores 414, 422, 424, and 444 in a variety of manners. For example, content can be stored within a relational database structure or can be stored within one or more files of a file storage system, where each file may or may not be indexed for information searching purposes. Further, the data stores 414, 422, 424, and 444 can utilize one or more encryption mechanisms to protect stored content from unauthorized access.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for dynamically translating application prompts comprising:
identifying a plurality of application prompts associated with a software application, wherein each application prompt comprises text of original language;
detecting an attempt of the software application to render one of the application prompts;
redirecting the attempt to a dynamic translation engine;
the dynamic translation engine dynamically and automatically translating the original text associated with the prompt into translated text of a target language;
substituting the translated text for the original text; and
rendering the application prompt after the substituting step.

2. The method of claim 1, further comprising:
using the dynamic translation engine to dynamically transcribe all of the application prompts from the original language to the target language.

3. The method of claim 1, further comprising:
establishing a likelihood threshold for the translation engine;
determining a likelihood value that the translated text is an accurate translation of the original text;
comparing the likelihood threshold and the likelihood value; and
selectively performing the substituting step depending on results of the comparing step.

4. The method of claim 1, wherein the target language is a user selected language that the software application does not natively support.

5. The method of claim 1, wherein the dynamic translation engine is located in a computing space remotely located from a computing space in which the software application executes.

6. The method of claim 5, wherein the software application includes internationalization support for a plurality of languages, and wherein the translation engine operates at an internationalization layer of the software application and simulates an availability of the target language, which is not otherwise available.

7. A method for adapting software applications for new languages comprising:
identifying a software application configured for a first language;
detecting a desired second language for the application, wherein a machine upon which the software application is implemented lacks native support for the second language;
determining a display object including original text written in the first language;
conveying the text to a remotely located networked machine along with an indicator of the second language;
receiving from the networked machine translated text in the second language that corresponds to the original text;
dynamically replacing the original text of the display object with the translated text; and
displaying the display object including the translated text.

8. The method of claim 7, further comprising:
providing a user selectable option for adapting the software application to different languages, said different languages including the second language; and
establishing the second language as a value for the user selectable option based upon a user established setting, wherein the detecting step detects the desired second language based upon the established value of the user selectable option.

9. The method of claim 7, wherein the software application comprises a plurality of application specific display objects that contain text, said plurality including said display object, each display object in the plurality being an application prompt, wherein said application prompts are automatically translated into said second language using steps of said method.

10. The method of claim 9, wherein the application prompts include application menu items and textual labels for graphical user interface elements of the software application.

11. The method of claim 7, further comprising:
intercepting the display object before it is displayed by the machine; and
performing the determining step after the intercepting step, wherein programmatic instruction resulting in the performance of the conveying, receiving, and replacing steps are implemented in software that operates independent of the software application.

12. The method of claim 7, wherein the software application includes local support for multiple languages that are handled by a linguistic engine of the software application, said multiple languages not including said second language, said method further comprising:
the linguistic engine receiving a request to adjust the display object for the second language;
the linguistic engine determining that the second language is not one of the locally supported multiple languages;
the linguistic engine dynamically conveying the text to the networked machine along with an indicator of the second language; and
the linguistic engine dynamically receiving the translated text from the networked machine.

13. The method of claim 7, further comprising:
providing an application program interface that performs said determining, conveying, receiving, and replacing steps, wherein the software application calls the application program interface when a user specified language for the software application is the second language.

14. The method of claim 7, further comprising:
determining a likelihood that the original text will be correctly translated into the second language;
comparing the likelihood against a previously established threshold; and
selectively translating the original text into the second language depending upon results of the comparing step.

15. The method of claim 7, further comprising:
a presentation object associated with the display object that includes the original text, wherein the presentation object is selectively displayed when the display object has focus.

16. The method of claim 7, further comprising:
providing a user selectable option to dynamically change an enablement state of dynamic translations for the software application, wherein when the option is enabled said determining, conveying, receiving, and replacing steps are automatically performed and when the option is disabled said determining, conveying, receiving, and replacing steps are not automatically performed.

17. A method for adapting software applications for new languages comprising:
receiving a plurality of translation requests from a remotely located software application to dynamically translate application prompts containing text into a language not natively supported by the software application;
dynamically translating the application prompts into the language responsive to the translation requests; and
providing the translated application prompts to the software application, wherein the application prompts include application menu items and textual labels for graphical user interface elements of the software application.

18. The method of claim 17, wherein the receiving, translating, and providing steps are performed in at least one of real-time and near-real-time.

19. The method of claim 17, wherein the software application is one of a plurality of different software applications supported by a networked machine that performs the receiving, translating, and providing steps.

20. The method of claim 17, wherein the local machine upon which the remotely located software application executes includes an application program interface for dynamic translations of application prompts, wherein the receiving, translating, and providing steps are performed by a networked machine, wherein interactions between the local machine and the networked machine that relate to dynamic translation of application prompts are conducted through the application program interface.
